(19) United States
(12) Patent Application Publication
(10) Pub. No.: US 2008/0270185 A1
(43) Pub. Date: Oct. 30, 2008

(54) METHOD AND DEVICE FOR PROVIDING A MEDICAL REPORT

(76) Inventors: Thomas Gossler, Uttenreuth (DE); Elmar Seeberger, Weissenburg (DE)

Correspondence Address: SCHIFF HARDIN, LLP;PATENT DEPARTMENT, 6600 SEARS TOWER, CHICAGO, IL, 60606-6473, US

(21) Appl. No.: 12/112,138

(22) Filed: Apr. 30, 2008

(30) Foreign Application Priority Data
Apr. 30, 2007 (DE) 10 2007 020 364.2

(51) Int. Cl. G06Q 50/00

(52) U.S. Cl. 705/2

(57) ABSTRACT

In a method, a device, a computer program product and a system for provision of a medical report in the framework of a medical finding under consideration of all relevant finding data, the medical report is generated with access to all relevant finding data at different computer-supported workspaces and is distributed online to further computer-supported workspaces. The medical report is thus provided for display on a monitor of arbitrary connected network nodes.

### BACKGROUND OF THE INVENTION

1. Field of the Invention

The invention is in the fields of medical technology and informatics and in particular concerns the provision of medical reports in the framework of a medical examination, in particular for making a diagnostic finding for a patient.

2. Description of the Prior Art

In the prevalent medical technology systems in use today, the following basic workflow is executed in the framework of a medical diagnosis. After an initial or follow-up examination of a patient, the generation of a medical report ensues in a second step, the medical report in particular including a diagnostic finding and is based on the acquired examination data. Different workflows that can be applied depending on the hospital department, time context, resources etc. can be provided based on this basic procedure. For example, dependent on the selected time context, in a first workflow a finding is in principle executed immediately after the preceding examination. As an alternative, in a different workflow the finding and/or the report generation ensues at an arbitrary later point in time, such that the examination data must initially be cached and then retrieved.

The primary application field of the present invention is in the field of radiology, in which computer-aided RIS (Radiology Information System) and PACS (Picture Archiving and Communication System) systems are typically used. In this case the medical report is based on a (normally imaging) medical examination at different modalities such as, for example, CT, x-ray apparatuses, ultrasound, PET, etc.

The generation of the medical report and the distribution thereof within the radiology department or even to workspaces or entities outside of the clinic (for example to the referring physician) is an essential consideration in the optimization of medical workflows since enormous costs and resources are connected with the generation of the medical report and in particular with the underlying medical examination. Reports for the referring physician or the treating physician and for the documentation within the clinic department have typically been generated by means of the RIS system.

In the systems conventionally in use, a physician generates a finding report after the medical (imaging) examination. The images are normally available to the physician as printouts (for example x-ray images) or as films, based on which the physician composes his or her medical report. If the report should be distributed to other entities, it is conventionally necessary to manually ship the entirety of the relevant documents (finding data, preliminary finding data, medical report etc.) to the requesting instance via the mail. This procedure is very time-consuming and deficient. Moreover, this represents an enormous potential for error because, for example, an incorrect association of examination data and recipient of the data is possible (such that, for example, either the requesting instance receives data of a different patient or the requested data are sent to a different physician).

### SUMMARY OF THE INVENTION

An object of the present invention is to improve the generation and the provision of a medical report, in particular to provide a more flexible and automated design.

The above object is achieved by a method, a device, a computer program product (computer-readable medium encoded with programming instructions) and a system for generation and/or provision of a medical report. The achievement of the object is subsequently described using the method. Mentioned features or alternative embodiments and/or advantages are hereby also likewise to be applied to the other categories (thus to the device, the computer program product and the system), and vice versa.

In a preferred embodiment of the inventive method for generation and/or provision of a medical report in the framework of a medical examination and/or finding under consideration of all relevant finding data. The following method steps are executed.

A medical report is recorded and/or generated of the medical report with access to all relevant finding data.

The medical report and/or relevant finding data are automatically made available for display on a monitor of a computer-aided workspace.

As used herein, the term “medical report” encompasses both image data and text data (in different formats such as, for example, Word format, PDF files or report data according to the DICOM-SR format (DICOM-SR: Structured Report) etc.). The medical report normally includes finding data, but can also include all or selected preliminary findings, measurement results or further relevant data or examination data (for example of a radiological examination). The primary application field of the present invention lies in the field of radiology and thus concerns a radiological examination at, for example, a CT scanner. The basic idea of the invention can likewise be applied to other imaging modalities or other medical examinations.

The finding can be an initial finding, a change to an existing, already-generated finding or another diagnostic measure. The inventive generation of the medical report typically ensues under consideration or integration of all or selected relevant finding data. In other words, all of the finding data that he classifies as relevant for the generation of the respective report are processed by the respective user by means of the inventive method.

In an embodiment, the user has a number of options via corresponding input possibilities on a user interface. For example, the user can set that in principle all available finding data are considered in the inventive method. It is also possible for the user to make a preliminary selection and so that only specific finding data are considered in the generation of the report. An important advantage of this embodiment is that not only the pure finding data (thus, for example, the images) are taken into account to generate the medical report, but also additional data that, for example, are available on other connected workspaces. Other connected workspaces can normally supply different types of further data that likewise can or should be used to generate the medical report. Such data can be text data, image data or other results or events such as, for example, data evidence of other or parallel examinations. According to the invention, such data can be automatically recorded and taken into account in the generation of the medical report. This typically ensues via presentation of the data on a monitor of the finding computer. This (automatic) access to further data has not been possible in the previous systems of the prior art. Such further data could previously be considered only by a manual procedure which, due to the high time expenditure, led to the situation that such data have normally been neglected in the generation of the medical report. Usable and relevant data for the generation of the report have thus disadvantageously been disregarded in part.

In the inventive method the medical report is typically generated for the first time or an already-existing report is modified. For this purpose, the already existing report is acquired (for example imported via an existing communication connection) in order to then be modified in a subsequent method step and to provide this in the modified form. If a new report should be generated, that this can proceed in multiple phases and include a complete or partial generation of the report. Preliminary stages of the report can thus also be retrieved and can be provided at other computer-aided workspaces. This has the advantage that the processing of the report generation is always current and also can be tracked by other instances.

According to the invention the generated or modified medical report should be distributed to requesting computer-supported entities. In other words, a number of computer-supported workspaces or entities are typically connected with one another via a communication network. One or more entities can dispatch a request to provide the medical report and/or to provide relevant finding data. This (requesting) message is typically conveyed via a central server. In the event that the computer-supported workspace has generated the request or the respective user is also authorized to receive the requested data, the data are displayed on a display device (monitor or display window of a wearable device). In a preferred embodiment the user can select which data the user would like to have displayed. For example, the user can have displayed only the medical report. Cumulatively or alternatively it is also possible to have displayed further data, for example the relevant finding data. The provision of the respective data (medical report and/or relevant finding data) ensues very flexibly and comprises a data transfer via a network (Internet, intranet, etc.), security checks, authorization checks and possibly an encryption of the data. It is likewise possible to provide the data to one or more computer-supported workspaces. The computer-supported workspaces are normally workstations. However, portable computer-supported units such as PDAs, laptops or further electronic handheld devices are also useable for this purpose. The computer-aided workstations are all equipped with corresponding web interfaces or, respectively, corresponding web tools that authorize them to receive data via a network.

In a preferred embodiment it is provided that the access to relevant finding data and/or the provision of the same or the medical report ensues independent of the storage location of the respective finding data or, respectively, report data. This is possible because all connected computer-supported entities exchange data with one another via a network. Medical reports therefore can also be made visible or provided across departmental and clinic borders. The further processing of the provided data is thereby completely open. It is thus possible to feed the data to a further data processing (for example an analysis or a post-processing), or the medical report can be printed out or be relayed to further instances.

In a further preferred embodiment, the finding data includes all or selected examination-related data, in particular finding data, image data, report data, preliminary findings, measurement results or further relevant events. A significant advantage of this feature is that the basis for the generation of the medical report can be expanded by incorporating not only the finding data, but also other relevant data can be taken into account. The decision or the selection of the data that are considered for the generation of the medical report thereby lies with the user. The quality of the medical report thus can be distinctly increased overall. By contrast to this, in conventional systems it is only possible to use information that are available within the RIS system. Further data, for example the processing of post-processing measures, further measurement results or other evidence or events that are available, for example, at other workstations or that require a different format, could previously not be considered. All data that are classified as relevant for the generation of the report can automatically be transferred to the respective finding station.

In a further preferred embodiment, the method includes a configuration of the data. In other words, according to the invention it is possible to format or to configure data from other systems (that exist in a different format, for example) such that they are prepared and can be used for the current system which is designed to generate the respective medical report. It is likewise possible to adaptively configure the medical report or portions thereof (for example the image or text contents). For example, it may be necessary that a remote entity requires the text data not in a Word format but, for example, as a PDF document. The requested data are correspondingly configured in a matching format and provided in that format. The configuration ensues dynamically; it is adapted to the respective computer-supported workstation or to the information technology environment of the respective workstation. For example, if no PDF reader is installed at a specific workstation, the system detects this automatically and the medical report is presented in a different format (for example in Word format).

In a preferred embodiment the inventive method includes data transfer via a network. The method can therefore be used very flexibly, and it is possible that the medical report is generated at a workstation that differs from the workstation at which the finding data have been acquired (for example the CT scanner) and/or it can moreover differ from the workstation at which the medical report should be displayed (for example at the workstation of the treating or referring physician). In other words, the workstations for acquisition of the finding data, for generation of the medical report and for display of the medical report can be entirely independent of one another, such that the respective actions can be executed at different systems or platforms.

A further advantage is in the temporal variability of the inventive method. The timing of the report generation is temporally independent of the timing of the provision of the medical report. In other words, the generated medical report can be retrieved at arbitrary workstations at arbitrary points in time. In a preferred embodiment the medical report and/or the relevant finding data are provided online.

In a further preferred embodiment the medical report and/or the finding data are continuously updated. An update process of these data is therefore automated, such that it is ensured that the respective current data set is always processed.

In an alternative embodiment, a data set including the medical report and/or the finding data is available in different compilation stages. The genesis (i.e. the temporal generation of the report) thus can be tracked. All stages or preliminary stages of the medical report are stored. Changes to an existing report and further developments in a report to be generated thus can be tracked.

In a further preferred embodiment of the method, a central report server with a report memory is accessed. The medical report and/or the finding data and possibly the compilation stages thereof are stored in up-to-date form in the report memory. They are distributed to decentralized network nodes via the report server.

In a further embodiment the medical report and/or the finding data can be accessed from at least one decentralized computer-supported node via the Internet (or via another network connection). The respective computer-supported nodes or workstations are provided with a networkable environment (with corresponding tools and applications) that enable the nodes to receive data and messages via the network.

The features and alternative embodiments mentioned in the preceding can also be mutually integrated into one embodiment. Furthermore, the features and embodiments mentioned in the preceding can also be applied in alternative achievements of the object.

As mentioned, the above object also is achieved in accordance with the invention by a device for provision of a medical report in the framework of an examination or finding with incorporation of relevant finding data, having: a report generator with corresponding user interface that is fashioned for generation of the medical report with access to relevant finding data or to acquire already-generated medical reports, and a distributor that is designed to provide the medical reports and/or the relevant finding data to decentralized, computer-aided, networkable workstations.

In a preferred embodiment the device also includes a central report server fashioned with a report memory to store the medical report and/or the finding data.

The above object also is achieved in accordance with the invention by a computer program product that can be loaded directly into a memory of a computer and that is encoded with programming instructions that cause the computer to implement the inventive method described above when the program code is executed by a processor.

The object also is achieved in accordance with the invention by a system for providing a medical report in the framework of an examination, that includes a network placing the report generator and the distributor in communication with each other.

### BRIEF DESCRIPTION OF THE DRAWINGS

FIG. 1 is an overview-like representation of the inventive architecture for provision of a medical report.

FIG. 2 illustrates modules for application of the inventive method.

### DESCRIPTION OF THE PREFERRED EMBODIMENTS

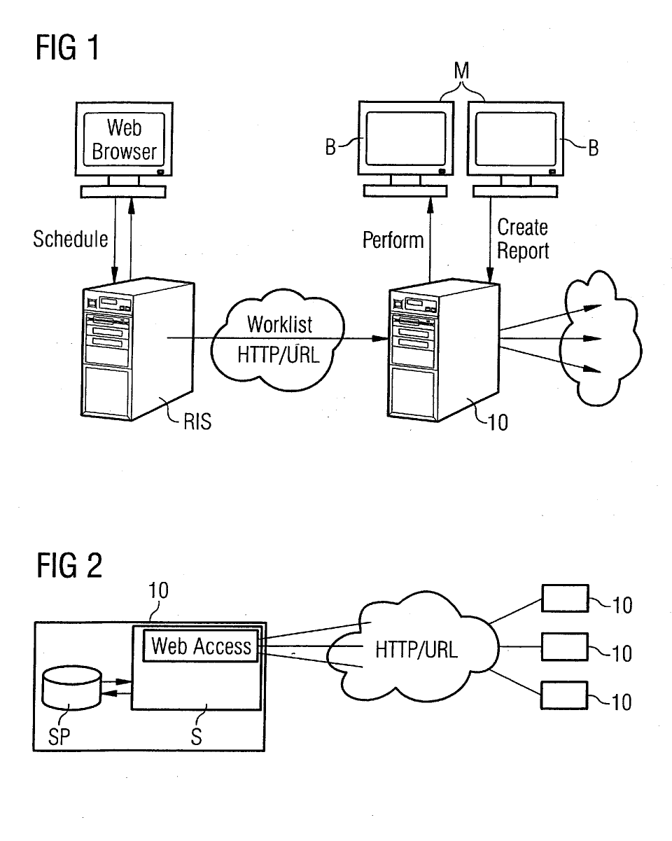

The basic components or modules for execution of the inventive method are presented in FIG. 1. The method for provision of a medical report B that is based on a medical examination (in particular a radiological examination) and comprises finding data, image data, report data and/or further measurement results [sic]). The finding data can have been acquired by different modalities. All computer-supported nodes or workspaces or workstations 10 are networkable and can exchange data (for example via the HTTP protocol). Each workstation 10 has a URL address via which it is identifiable on a one-to-one basis. Access to the local nodes 10 or other “remote” nodes 10 at which relevant finding data are stored is executed to generate the medical report B. These can be arbitrary web clients, the RIS system or the modalities themselves. The generation of the medical report B is prepared in that all relevant finding data of different disk spaces and workstations 10 are collected and can be considered for generation of the medical report B. After generation of the report B, it is relayed to requesting workspaces alone or together with the relevant finding data. The medical report B and/or the finding data can thus be retrieved online at arbitrary linked network nodes 10.

FIG. 2 shows that the inventive device comprises a report memory SP and a central report server S that are engaged in data exchange with one another. Moreover, each network node 10 is equipped with a network access (web access) that is fashioned as a sub-system at the report server S. The central report server S communicates with arbitrary web clients 10 (such as, for example, with the RIS system) via the HTTP protocol.

The network nodes 10 that request the medical report B must be provided with a corresponding network environment and advantageously possess a monitor M that is fashioned to display the medical report B.

To execute a radiological examination the respective scanner must be configured for the application case so that the respective finding data can be acquired. Therefore the technicians or the radiologists receive what is known as a worklist that is provided by the RIS system. Further connected workspaces concern, for example, the acquisition of the image data, a post-processing of the image data and/or further applications and tools for generation and documentation of examination data and further evidence. The respective nodes 10 are equipped with a network interface. The report server S at the respective workspace 10 supplies the relevant data (thus the report data, finding data) or further acquired measurement results. As soon as the finding data change an update of the respective data ensues in the report memory SP. With this it is ensured that report data newly generated during a post-processing or during later evaluations of images are automatically stored and are available in a respective updated form. The respective data are stored in a network-compatible report format. The report files are stored in the report memory SP with a networkable environment that is accessible online via the RIS system by means of a predefined URL address.

During his session at the RIS system the radiologist can display and view, copy, download or otherwise further process the medical reports B. Moreover, the radiologist can have presented only sections of the medical report such as, for example, abstracts, exclusively images or only selected images that, for example, are the basis of a current post-processing. Moreover, the radiologist can forward the data to further applications or workstations 10.

The type and number of the connected workstations 10 is thereby not limited. According to the invention, not only the radiologists at the RIS system but also other users at other workspaces 10 can therefore track the progress in the processing of the finding data, the analysis of the image generation or the image importation and the report generation.

Via the inventive provision of the reports in digital form over the network or, respectively, online, the radiology department gains the advantage that fewer user interactions are necessary for report generation than were previously necessary via incompatible systems of the radiology department. Moreover, the costs and the time with regard to the report generation are clearly reduced. Furthermore, a significantly improved quality results, both with regard to the internal documentation and with regard to the external relaying of report data.

In order to give consideration to the different information technology environments of the respective workspaces 10, in a preferred alternative embodiment of the invention it is provided to effect a conversion of the generated medical report B. This ensures that the generated medical report B can also be presented or displayed on the respective target computer (thus the workstation 10 that has requested the medical report B).

The report server S provides the report data in different formats (for example in HTML, XML, PDF, TXT etc.). According to the invention, the access to the medical reports B is possible from arbitrary workstations 10 that are connected to the RIS system or from workstations 10 with a web browser. The respective client then requires an access to the web portal of the report server S.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for providing a medical report for a medical examination with finding data resulting from the medical examination integrated into the medical report, comprising the steps of:
producing a medical report with electronic access to multiple sources of relevant finding data and including the relevant finding data from said multiple sources in said medical report; and
electronically providing the medical report with the finding data included therein in a form for display at a monitor of a computer-supported workspace.

2. A method as claimed in claim 1 comprising electronically accessing said finding data for producing said medical report independently of respective storage locations of said finding data.

3. A method as claimed in claim 1 comprising selecting said finding data from the group consisting of data resulting from an examination of a subject, data representing an image of a subject, data representing a medical measurement made on a subject, and preliminary findings obtained before said medical examination.

4. A method as claimed in claim 1 comprising configuring said finding data to conform to a predetermined data format.

5. A method as claimed in claim 1 comprising continuously updating at least one of said medical report and said finding data.

6. A method as claimed in claim 1 comprising accessing said finding data from said multiple sources through a central report server with an associated report memory.

7. A method as claimed in claim 1 comprising allowing access to said medical report from at least one decentralized computer-supported node via the Internet.

8. A device for providing a medical report for a medical examination with finding data resulting from the medical examination integrated into the medical report, comprising:
a processor configured to produce a medical report with manual input and with electronic access to multiple sources of relevant finding data and to include the relevant finding data from said multiple sources in said medical report; and
a report distributor configured electronically to provide the medical report with the finding data included therein in a form for display at a monitor of a computer-supported workspace in communication with the report distributor.

9. A computer-readable medium encoded with programming instructions that are loadable into a computer for generating a medical report for a medical examination with finding data integrated into the medical report, said programming instructions causing said computer to:
produce a medical report with manual input and with electronic access to multiple sources of relevant finding data and to include the relevant finding data from said multiple sources in said medical report; and
electronically provide the medical report with the finding data included therein in a form for display at a monitor of a computer-supported workspace.

10. A system for providing a medical report for a medical examination with finding data resulting from the medical examination integrated into the medical report, comprising:
a report generator configured to produce a medical report with manual input and with electronic access to multiple sources of relevant finding data and to include the relevant finding data from said multiple sources in said medical report;
a computer-supported workspace remote from said processor, comprising a monitor;
a report distributor configured to electronically provide the medical report with the finding data included therein in a form for display at said monitor of said computer-supported workspace; and
a network placing said report generator and said report distributor in communication with each other and placing said computer-supported workspace and said report distributor in communication with each other.
